(19) United States
(12) Patent Application Publication
(10) Pub. No.: US 2020/0341115 A1
(43) Pub. Date: Oct. 29, 2020

(54) SUBJECT IDENTIFICATION IN BEHAVIORAL SENSING SYSTEMS

(71) Applicant: Massachusetts Institute of Technology, Cambridge, MA (US)

(72) Inventors: Dina Katabi, Boston, MA (US); Rumen H. Hristov, Cambridge, MA (US); Chen-Yu Hsu, Cambridge, MA (US); Guang-He Lee, Cambridge, MA (US); Mingmin Zhao, Cambridge, MA (US)

(21) Appl. No.: 16/860,591

(22) Filed: Apr. 28, 2020

Related U.S. Application Data
(60) Provisional application No. 62/839,723, filed on Apr. 28, 2019.

(51) Int. Cl. G01S 7/41; G06K 9/62; G06K 9/46; G06K 9/00; H01Q 21/08; G01S 7/35; G06N 3/04; G06N 3/08

(52) U.S. Cl. CPC G01S 7/415; G06K 9/6267; G06K 9/6256; G06K 9/4661; G06K 9/00348; G06N 3/08; H01Q 21/08; G01S 7/417; G01S 7/352; G06N 3/04; G06K 9/00362

(57) ABSTRACT

In a data-processing system a frame generator generates frames from the reflection data representing successive patterns of reflection that result from having launched a transmitted radio signal into a space. Each frame indicates a pattern of reflection at a particular time that corresponds to the frame. A trajectory generator receives the frame data and uses it to identify of a subject's trajectory through the space. An identification module identifies the subject based at least in part on the trajectory.

### RELATED APPLICATIONS

This application claims the benefit of the Apr. 28, 2019 priority date of U.S. Provisional Application 62/839,723, the contents of which are herein incorporated by reference.

### STATEMENT AS TO FEDERALLY SPONSORED RESEARCH

This invention was made with Government support under Grant No. AST1343336 awarded by the National Science Foundation (NSF). The Government has certain rights in the invention.

### BACKGROUND

This invention relates to the identification of one or more subjects in radio-frequency based behavioral sensing systems.

Understanding subjects' behavior at home is central to behavioral research. For example, social researchers are interested in studying domestic abuse, and healthcare professionals are interested in caregiver-patient interaction. Some of these studies rely on diaries and questionnaires. However, these are subjective, erroneous, and difficult to sustain in longitudinal studies. Other studies rely on monitoring electronic tracking devices. However, these are cumbersome to wear on a consistent basis.

### SUMMARY

In some aspects, an apparatus as described herein automatically collects behavior-related data without asking subjects (e.g., people) to write diaries or wear sensors. To do so, such an apparatus transmits a low power wireless signal and analyzes its reflections from the environment. Those reflections are mapped to how a subject interacts with the environment (e.g., whether the subject accesses the medicine cabinet) and how subjects interact with each other (e.g., whether or not they watch TV together).

In other aspects, an apparatus repeatedly emits radio frequency signals into an environment and receives reflections of the emitted signals from objects in the environment (e.g., using an FMCW technique). For each repetition of a radio frequency signal, the received reflections of the signal are used to determine a location of the objects in the environment. The location of the objects in the environment for one repetition can be represented as an “RF Frame.” By repeatedly emitting signals and receiving reflections, a time-series of RF Frames is compiled and can be used to determine motion of the objects in the environment over time.

Still other aspects described herein extract information about motion of subjects (e.g., people) in the environment and represent that motion as “tracklets.” A tracklet is a portion of a subject's two or three-dimensional trajectory through the environment. Tracklets representing subjects' motion can be used to infer the subjects' behavior (e.g., whether the subjects generally go to bed at 10 PM and eat breakfast at 7:30 AM).

Some aspects analyze the collected RF Frames and corresponding tracklets to identify one or more subjects moving in the environment. In some examples, the analysis of the collected RF Frames and tracklets to identify a subject accounts for spatial features related to a subject's height and build as well as temporal features such as a subject's movement dynamics and gait. In some examples, a convolutional neural network identifies subjects based on the RF Frames and tracklets.

In some aspects, when the convolutional neural network is trained in a training period, subjects wear a wearable device, such as an accelerometer. During the training period, RF signals and acceleration data are collected. The RF signals are processed to extract RF frames and tracklets for subjects in the environment. For each tracklet, the motion along the tracklet is correlated with the acceleration from the wearable sensors. The tracklet is then labeled with the identity of the user whose acceleration matches the motion in the tracklet. Once the system has enough labeled data, the subjects can stop wearing the accelerometer. The process of identifying a subject then proceeds using RF signals alone.

Some aspects feature a system configured to receive wireless signals from the environment, to process the received wireless signals to identify signals reflected off people, and to compare the reflected wireless signals with data from a portable device to identify the person off whom the signal was reflected.

Yet other aspects feature a system that uses data from a portable or personal device to create a classifier that identifies the person and uses the classifier to identify people based on wireless signals reflected off their bodies.

Other aspects use wireless signals reflected off people's bodies to track interactions between those people. Examples of interactions are interactions between a caregiver and a care recipient. A specific example of an interaction between a caregiver and care recipient is a caregiver delivering medication to a care recipient.

The apparatus and method described herein offer advantages over conventional behavioral sensing systems by enabling deployment in new homes without requiring subjects in those homes to annotate behavioral data produced by the system with subject identification information. Thus, the identities of the subjects can be determined without requiring the subjects to annotate the behavioral data.

The various aspects of the invention described herein reduce overhead associated with conventional in-home longitudinal behavioral studies. They do so by relying on radio (RF) signals that bounce off subjects' bodies to enable behavioral sensing at home without requiring that subjects maintain diaries or wear wearable devices

In one aspect, the invention features a method for identifying a subject moving through a space. Such a method includes emitting a transmitted signal and receiving a reflected radio signal. The transmitted signal includes repetitions of a transmitted-signal pattern and the reflected radio signal includes reflections of the transmitted signal. The method continues with processing the received signals to form successive patterns of reflections of the transmitted signal and determining the subject's trajectory through the space based on the successive patterns of reflections. In addition, the method includes determining the subject's identity based at least in part on the trajectory. The method is usable to obtain track and identify two or more subjects who are moving concurrently through the space.

Among the practices of the method are those in which determining the subject's identity includes using a classifier to process the trajectory of the subject moving through the space and the successive patterns of reflections of the transmitting signal for the subject. Examples of classifiers include neural networks, and in particular, convolutional neural networks.

Among practices that rely on a classifier are those that include a further step of receiving training signals. These training signals comprise received reflected signals and corresponding motion signals. The motion signals are signals that have been collected using a device that moves with the subject. An example of such a device is an accelerometer affixed to the subject, in which case the motion signal includes accelerometer data. In either case, the training signal is used to determine configuration parameters for the classifier.

In another aspect, the invention features a data-processing system configured to receive, from a wireless sensor, reflection data indicative of a reflected radio signal. The wireless sensor couples to an antenna that is disposed to launch a transmitted radio signal into a space and to receive a reflected radio signal from a subject that is moving through the space. The transmitted radio signal comprising repetitions of a transmitted signal pattern. The resulting reflection data represents successive patterns of reflection that result from having launched the transmitted radio signal.

Such a data-processing system includes a frame generator, a trajectory generator, and an identification module.

The frame generator generates, from the reflection data, a series of frames, each of which includes frame data indicative of a pattern of reflection at a particular time that corresponds to the frame. The series of frames defines a succession of patterns of reflections.

The trajectory generator receives the frame data from the frame generator. It then obtains, from the patterns of reflections, trajectory data indicative of a subject's trajectory through the space.

The identification module identifies the subject based at least in part on the trajectory.

In some embodiments, the identification module comprises a neural network that has been trained to use the trajectory to identify the subject based on the subject's characteristic movements. Among these are embodiments that rely on a convolutional neural network. that has been trained to use the trajectory to recognize the subject based on the subject's characteristic movements. A particularly useful example of a characteristic movement is the subject's characteristic gait.

In other embodiments, it is useful to eliminate extraneous data. Such embodiments include a neural network that includes a multiplier for receiving the frame data. The mask defines a volume along the trajectory and suppresses frame data that represents reflections from outside that volume.

Yet other embodiments are those in which the identification module comprises a neural network that comprises branches. Each such branch has multiple layers. The branches connect to form a fully-connected layer. In operation, each branch receives only a portion of the frame data. In some embodiments, each branch receives and processes a projection of the frame data into a subspace that has fewer dimensions than the space

In still other embodiments, the frame comprises projections of the data into subspaces of lower dimensionality than that of the space. In such embodiments, the identification module comprises multiple branches, each of which processes one of the projections. A suitable implementation of such an embodiment is one in which branch is a branch of a convolutional neural network and in which the branches combine to form a fully-connected layer of the convolutional neural network.

Still other embodiments are those in which the identification module comprises a neural network that includes first and second branches and a fully-connected layer at which the first and second branches connect.

However, in addition, the neural network features first and second multipliers. The first multiplier applies a first mask to a first projection that is to form a masked first projection. This masked first projection is ultimately processed by the first branch. Similarly, the second multiplier applies a second mask to a second projection to form a masked second projection. This masked second projection is ultimately processed by the second branch.

Preferably, the first and second projections are projections of the frames into corresponding first and second sub-spaces of the space through which the subject moves.

The first mask defines a volume along a projection of the trajectory into the first sub-space such that, when applied to the first projection, the first mask suppresses reflections from outside the volume. Similarly, the second mask defines a volume along a projection of the trajectory into the second sub-space, such that, when applied to the second projection, the second mask suppresses reflections from outside the volume.

Yet other embodiments feature an identification module that further comprises an identification network. The identification network is one that is trained to recognize the subject based on characteristics of the subject's gait. In such embodiments, the data-processing system is further configured to receive data representative of movement of the subject during a training period.

Still other embodiments include an identification module that further comprises an identification network. The identification network is one that is trained to recognize the subject based on characteristics of the subject's movement and on the subject's body characteristics. In such embodiments, the data-processing system is further configured to receive data representative of movement of the subject during a training period.

Also among the embodiments are those in which the identification module further comprises a neural network that is configured to be trained to recognize the subject based on the subject's spatial and temporal features. In such embodiments, the network comprises layers that carry out spatial and temporal convolution of the data indicative of the subject's body shape and the subject's trajectory through the space.

Still other embodiments are those in which the data-processing system is configured to receive acceleration data from an accelerometer that is being worn by the subject and to use the acceleration data to learn characteristics of the subject's movement for use in identifying the subject in a post-training phase of operation in which, after the subject has removed the accelerometer, the subject's motion through the space is tracked and the subject identified based on the subject's characteristic movements.

Still other embodiments are those in which the identification module includes a neural network that comprises a motion branch and a position branch. In such embodiments, the motion branch processes data indicative of the subject's motion and the position branch processes data representative of the subject's trajectory. The first and second branches combine at a fully-connected layer of the neural network.

In other embodiments, the identification module further comprises a neural network that is trained by varying a model parameter to minimize a cross-entropy loss.

Yet other embodiments feature an antenna. In such embodiments, the antenna has antenna elements that extend along first and second perpendicular directions. These directions correspond to first and second portions of the frame data.

Still other embodiments include those in which transmitted-signal pattern comprises the pattern of an FMCW signal. An example of such a pattern is a chirp.

In some embodiments, the subject is a first subject of a plurality of subjects, all of whom move through the space concurrently. In such embodiments, the identification module is configured to identify each of the subjects based at least in part on a trajectory that corresponds to the subject.

In another aspect, the invention features a data-processing system in which a frame generator generates frames from the reflection data representing successive patterns of reflection that result from having launched a transmitted radio signal into a space. Each frame indicates a pattern of reflection at a particular time that corresponds to the frame. A trajectory generator receives the frame data and uses it to identify of a subject's trajectory through the space. An identification module identifies the subject based at least in part on the trajectory.

Additional details and embodiments can be found in the attached appendix, titled “Enabling Identification and Behavioral Sensing in Homes using Radio Reflections” (13 Pages), which is hereby incorporated by reference in its entirety.

Wireless localization approaches that may be used in the procedures described herein are described in the following US Patent Applications, which are incorporated herein by reference: U.S. application Ser. No. 15/120,864, titled “OBJECT TRACKING VIA RADIO REFLECTIONS,” filed Aug. 23, 2016, U.S. application Ser. No. 14/510,263 titled “MOTION TRACKING VIA BODY RADIO REFLECTIONS,” filed on Oct. 9, 2014, U.S. Provisional Application No. 61/943,957 titled “MULTI-PERSON MOTION TRACKING VIA BODY RADIO REFLECTIONS,” filed on Feb. 24, 2014, and U.S. Provisional Application No. 61/985,066 titled “MULTI-PERSON MOTION TRACKING VIA BODY RADIO REFLECTIONS,” filed on Apr. 28, 2014.

Examples of the approaches described herein may be implemented in hardware, in software, or a combination of hardware and software. The software may include instructions stored on non-transitory machine-readable medium for causing a data processing system to execute the steps of the procedures described herein.

### BRIEF DESCRIPTION OF THE FIGURES

FIG. 1 shows an apparatus for identifying and tracking subjects as they move through a space.

FIG. 2 shows an individual frame obtained by the apparatus shown in FIG. 1;

FIG. 3 shows the space depicted in FIG. 1 with tracks made by two subjects as they wander through the space shown in FIG. 1;

FIG. 4 shows a neural network implemented by the identification module of FIG. 1;

FIG. 5 shows an accelerometer to be worn during a training period in which the identification module learns to identify subjects based on their movements; and

FIG. 6 shows a neural network that is used with the accelerometer data provided by the accelerometer of FIG. 5.

### DETAILED DESCRIPTION

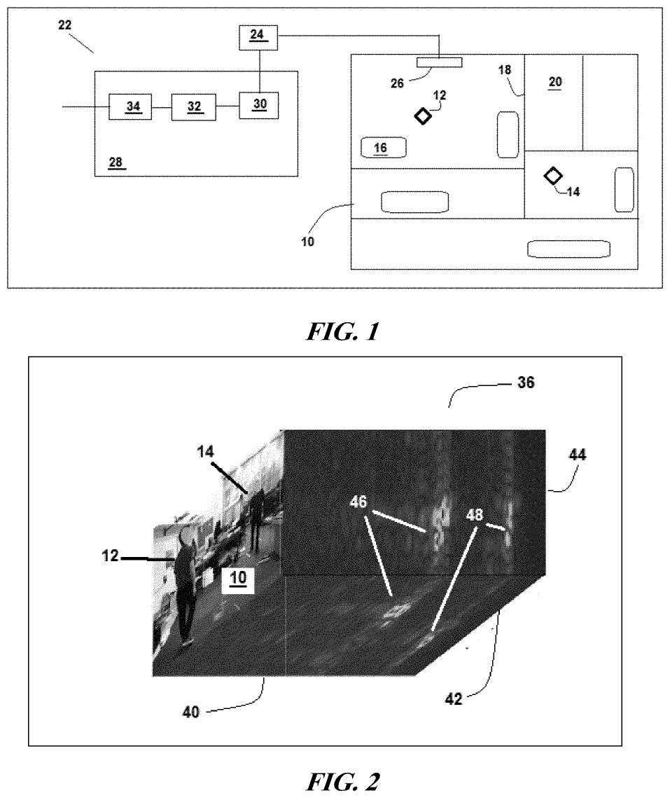

FIG. 1 shows a space 10 in which first and second subjects 12, 14 move about as they carry on their activities within the space 10. Examples of such a space 10 include a home or apartment. The space 10 typically includes various immobile furnishings 16 as well as walls 18 that partition the space 10 into rooms 20.

In many cases, it is desirable to collect data indicative of how the subjects 12, 14 move about the space 10. An apparatus 22 for collecting such data features a wireless sensor 24 that causes an antenna 26 to transmit radio waves into the space and to receive reflections of those waves from the various furnishings 16 and, most importantly, from the subjects 12, 14 that occupy the space 10. These radio waves carry a signal that defines a locus of points in the frequency domain. For simplicity in processing, a suitable signal is an FMCW signal, which defines tone having a frequency that varies in time. In some cases, the tone's frequency varies linearly in time. In such cases, a suitable tone has a frequency that ranges from 5.46-7.24 GHz.

The wireless sensor 24 provides data indicative of the reflections to a data-processing system 28. In connection with processing this data, the data-processing system 28 implements a frame generator 30, a trajectory generator 32, and an identification module 34.

In FIG. 1, the apparatus 22 is shown outside the space 10 only for convenience in illustration. In fact, a typical implementation could be placed inside the space 10.

In some implementations, the wireless sensor 24 and antenna 26 are integrated on a printed-circuit board. In other implementations, the antenna 26 is on a structure that is separate from the printed-circuit board. The data-processing system 28 is a single-board computer that processes signals received from circuitry on the printed-circuit board and sends the resulting data to the cloud via a wireless network. During a training phase, the data-processing system 28 also manages a connection with accelerometers that are worn by the subjects 12, 14 during training. Such an implementation can be made compact enough to fit within a stand-alone box and hung on a wall. The dimensions of a typical box are 12×15×1.5 inches.

Referring now to FIG. 2, each frame generator 30 processes the data that arrives from the wireless sensor 24 to form RF frames 36, which will be referred to herein as “frames” for brevity.

Each frame 36 is a snapshot of the reflected signal within the three-dimensional space 10. Since a three-dimensional space requires three coordinates to define a point, the illustrated frame 36 has a distance axis 40 and two additional axes for two spatial angles, namely a horizontal-angle axis 42 and a vertical-angle axis 44.

The frame 36 shown in FIG. 2 shows the locations of first and second volumes 46, 48 within the space 10 that have particularly high reflectivity. These are interpreted as corresponding to volumes occupied by the first and second subjects 12, 14 of that space 10. The subjects 12, 14 associated with the first and second volumes 46, 48 can be seen in visible light in in the accompanying photograph of the space 10.

The signal that gives rise to the first and second volumes 46, 48 is complex-valued. Only the magnitude is shown in the frame 36 in FIG. 2.

The frame generator 30 obtains these frames 36 at successive times. As such, each frame 36 can be used as a basis for a short clip of an RF video that provides information about motion of the subjects 12, 14 within the space.

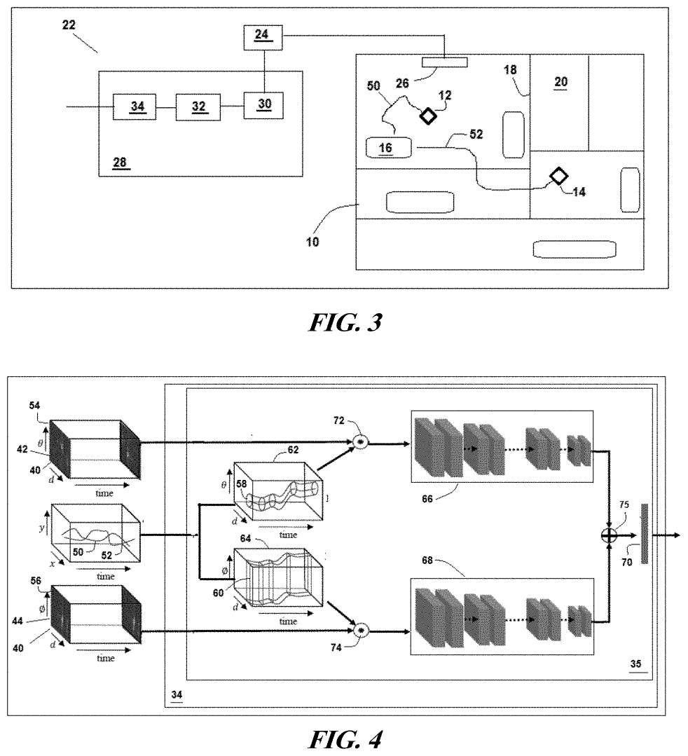

The frame generator 30 provides these frames to the trajectory generator 32. Referring to FIG. 3, the trajectory generator 32 uses the frames to identify short segments of the subjects' trajectories 50, 52 through the space 10. These short segments of a trajectory 50, 52 are referred to herein as “tracklets.”

In a typical application within a home, there may be multiple subjects 12, 14 moving through the space. Under these circumstances, it is useful to be able to identify which subject 12, 14 caused a particular trajectory 50, 52. This is the function of the identification module 34, which in the illustrated embodiment, is implemented using an identification neural network 35, referred to herein as simply the “identification network 35.” Details of the identification network's architecture are discussed in connection with FIG. 4.

When coupled with a floor plan of the space, the output of the identification module 34 can be used as a basis for determining how the subjects 12, 14 interact with the space 10 and with each other. For example, the output can be used to answer such questions as, “Do the subjects 12, 14 sleep in the same bed?” or “Who wakes up first?”

In a typical embodiment, the antenna 26 is an array antenna in which array elements are distributed in two dimensions. A particularly useful embodiment is an antenna 26 in which antenna elements are arranged at regular intervals along vertical and horizontal axes. As will be seen in connection with FIG. 4, this arrangement provides a particularly convenient way to separate signals that come from different locations in the three-dimensional space 10.

Referring now to FIG. 4, the frame generator 30 uses the antenna elements along the horizontal axis to generate successive two-dimensional horizontal frames 54 and uses the antenna elements along the vertical axis to generate successive two-dimensional vertical frames 56. The horizontal frames 54 are defined by the distance axis 40 and the horizontal-axis 42. The vertical frames 56 are defined by the same distance axis 40 and the vertical-angle axis 44 instead. The horizontal and vertical frames 54, 56 can therefore be viewed as projections of the frame 36 shown in FIG. 2 into two subspaces.

The frame generator 30 generates data indicative of a reflection from a particular distance and angle. It does so by evaluating a double-summation for the horizontal frames 54 and another double-summation for the vertical frames 56.

The double-summations are identical in form and differ only in details related to the structures of the horizontal and vertical lines of antennal elements and in whether the vertical or horizontal angle is being used. Thus, it is sufficient to show only one of the double summations below:

$$P ( d , θ ) = {\sum }_{n = 1}^{N} {\sum }_{t = 1}^{T} {s}_{n , t} {e}^{j 2 π kdt / c} {e}^{j 2 π nl cos ( θ ) / λ}$$

In the foregoing double summation, P(d, θ) represents the value of the reflection from a distance din the direction θ, s_{n,t} represents the t^{th} sample of the reflected chirp as detected by the n^{th} antenna element in the line of antenna elements, c and A represent the radio wave's velocity and its relevant wavelength, N represents the total number of antenna elements in the relevant axis of antenna elements, T represents the number of samples from the relevant reflection of the outgoing chirp, l represents the spatial separation between adjacent antenna elements, and k represents the slope of the chirp in the frequency domain.

As a result, at each step, it is possible to represent the reflected signal using its projection on a horizontal plane and on a vertical plane. As is apparent from FIG. 2, the horizontal frame 54 captures information concerning a subject's location and the vertical frame 56 captures information concerning the subject's build, including such features as the subject's height and girth. Differences between successive frames in a sequence of horizontal and vertical frames 54, 56 provide information concerning each subject's characteristic gait and manner of movement. A preferred embodiment operates at a frame rate of thirty frames-per-second. This is sufficient to assume continuity of locations.

Collectively, information in the horizontal and vertical frames 54, 56 provides information that can be used to identify each subject 12, 14, including spatial information. The existence of spatial information is of considerable advantage. Such information is not available when relying on the Doppler effect or when relying on channel state identification in a wireless network.

As suggested by FIG. 2, a subject's location can be estimated by estimating the location of the center of the reflection as shown in the horizontal frame 54. Estimation of this location in successive frames 54, 56 permits the evaluation of short trajectories, referred to herein as “tracklets.” By connecting a tracklet between a pair of frames with a tracklet in a successive pair of frames, it becomes possible to construct corresponding trajectories 50, 52 for the first and second subjects 12, 14, as shown in FIG. 3. To accommodate the presence of noise, it is particularly useful to apply a Kalman filter on all such location measurements.

In some cases, tracklets do not align closely. For example, there may be a large discontinuity between successive frames. This can be caused by an occlusion, for example as a result of a metallic obstacle.

To accommodate such cases, it is useful to define a threshold and to initiate a new trajectory if the misalignment exceeds that threshold. In a preferred practice, the threshold is fifty centimeters. After initiating a new trajectory, it becomes necessary to re-identify the subject 12, 14 generating the newly initialized trajectory.

The trajectories shown in FIG. 3 indicate that subjects 12, 14 do not walk in straight lines. In the illustrated example, the two subjects 12, 14 have just gotten up from the table 16. The first subject 12 has moved to look out the window and has just turned inward to move to a location that is as yet undetermined. The second subject 14 appears to have made a beeline for the bathroom for some reason. The second subject's track ends as shown because the bathroom is on the edge of the antenna's coverage area.

Identification is carried out using the identification module 34. A typical identification module 34 collects information during the course of an observation window. The observation window is selected to be long enough to capture information about a subject's gait, yet still short enough to allow acceptably rapid identification. A suitable length for an observation window given typical movements of a human being indoors is approximately five seconds.

During each such observation window, the identification network 35 receives frames and corresponding tracklets from the same time interval. For each observation window, the identification module 34 tags each tracklet with an identity.

In general, the reflected signal that is received during the course of an observation window includes considerable information that is not needed for identification. This includes reflections from static objects and from certain kinds of subject activity.

To remove reflections from static objects, it is useful to subtract consecutive frames. The resulting frame differential omits reflections from static objects and leaves behind only reflections from moving objects, i.e., the subjects 12, 14.

However, there are certain activities carried out by a subject 12, 14 that do not help very much when attempting to identify the subject 12, 14. It is therefore useful to also omit reflections arising from these non-informing activities. For example, observation of a subject 12, 14 setting a table or kneading dough is often not as revealing as observing a subject 12, 14 actually walk from one room to another.

The result of training the identification network 35 with such non-informing activities is often over-fitting of training data and poor generalization on test data. Thus, it is useful to further filter the information to exclude movement associated with non-informing activity. This will leave behind the most useful information, namely observations of a subject 12, 14 walking.

A suitable procedure for distinguishing walking periods from periods of non-informing activity is to estimate the diameter of a circle that bounds the tracklet. If the diameter exceeds a distance threshold, the subject 12, 14 associated with that tracklet is assumed to be moving. In such cases, the frames and tracklet are passed to the identification network 35 for further processing. During the course of the observation window, the identification network 35 estimates the subject's identity. If a subject 12, 14 stops walking and stays in the same location, that subject's identity is assumed to persist.

When multiple subjects 12, 14 are present, it is quite probable that both subjects 12, 14 will be moving during the same observation window. Directly feeding such data to the identification network 35 results in confusion because it is not clear which subject's identity the identification network 35 should learn or predict. To avoid this difficulty, it is useful to spatially separate reflections from each subject 12, 14. This permits each subject's reflections to be operated upon separately thus easing the neural network's task of inferring that subject's identity.

The process of separating the reflections includes defining a circle 58 around the subject's location in the horizontal frame 54 and defining, in the vertical frame 56, a volume 60 that extends upward from that circle 58. A suitable radius for such a circle 58 is a half-meter. Any reflection from the upwardly-extending volume 50 is assumed to come from the same subject 12, 14 who is in the circle 58.

The foregoing definitions of a circle 58 and a volume 60 result in a horizontal mask 62 and a vertical mask 64. These can be used in tandem to filter out a particular one of the trajectories 50, 52. By using these masks 62, 64, it is possible to provide the identification network 35 with information concerning only a single subject 12, 14 during the course of the observation window, even if many subjects are concurrently moving in the space 10.

For each space 10 in which the apparatus 22 is to be deployed, it is necessary to train the identification network 35 to identify the subjects 12, 14 who are expected to occupy that space 10. This enables the identification network 35 to label the trajectories with the correct subjects' identities.

As shown in FIG. 4, the identification network 35 includes first and second branches 66, 68. The first branch 66 processes horizontal frames 54. The second branch 68 processes vertical frames 56. The first and second branches 66, 68 merge into a fully-connected layer 70. The fully-connected layer 70 aggregates the information from the first and second branches 66, 68.

Each of the first and second branches 66, 68 has multiple layers. The number of layers in each branch 66, 68 is large enough to abstract the relevant information but still small enough to avoid overfitting. In a preferred embodiment, each of the first and second branches 66, 68 has ten layers with a kernel of 5×3×3 in the three dimensions. These were chosen empirically.

The identification network 35 also includes the masks 62, 64 for separating trajectories 50, 52 associated with different subjects 12, 14. These masks 62, 64 promote the neural network's ability to identify different subjects 12, 14 who move concurrently through the space 10.

First and second multipliers 72, 74 carry out a filtering process using the first and second masks 62, 64. The first multiplier 72 carries out element-by-element multiplication between the horizontal mask 62 and the horizontal frames 54. The first multiplier 74 carries out element-by-element multiplication between the vertical mask 64 and the vertical frames 56. Such an element-by-element multiplication can also be referred to as a “dot product.” Together, these operations ensure that only the reflection from the subject associated with the relevant masks 62, 64 is passed to the first and second branches 66, 68.

The neural network's architecture captures information related to both spatial features and temporal features. Examples of spatial features include the subject's build and height. Examples of temporal features include the subject's gait and movement dynamics. To capture both spatial and temporal features, each layer carries out spatial and temporal convolution to aggregate information across space and time. In every other layer, the number of channels is doubled, and the number of dimensions is halved. A final layer carries out average pooling in both spatial and temporal dimensions. This results in two feature vectors, one from each branch. A concatenator 75 receives the two feature vectors and concatenates them. The resulting concatenated feature vector is then provided to the fully-connected layer 70, which predicts the subject's identity

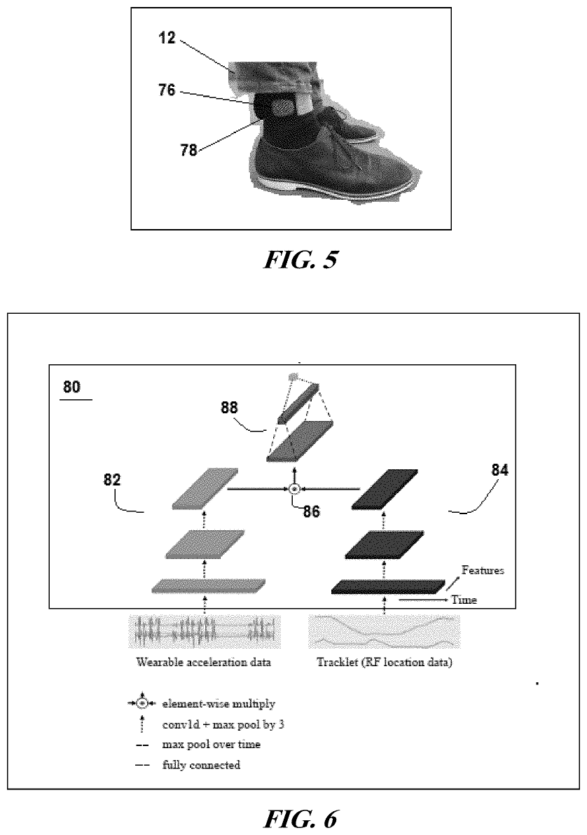

Referring now to FIG. 5, training the identification network 35 is carried out by having a subject 12 wear an accelerometer 76 for a brief period while collecting training data. The accelerometer 76 is best mounted at the subject's ankle with the ankle strap 78 since the distal end of the leg will undergo the greatest acceleration when walking. The accelerometer 76 streams acceleration data to the apparatus 22 using a Bluetooth low energy protocol. Preferably, the accelerometer 76 has a battery that will last longer than the expected training period. This avoids having to rely on a subject to charge the accelerometer 76.

During the training period, the apparatus 22 collects radio signals via the antenna in the manner described above. However, it also collects acceleration data from the accelerometer 76. The apparatus 22 then processes the radio signals to extract the tracklets for whichever subject 12, 14 is wearing the particular accelerometer 76. It then labels that tracklets with the subject's identity. Once the identification module 34 has acquired enough labeled tracklets for all the subjects, subjects 12, 14 will no longer have to wear accelerometers 76. Identification can proceed using the radio signals alone.

The training procedure includes minimizing a cross-entropy loss. This includes minimizing the following double summation:

$${min}_{θ} {\sum }_{n = 1}^{N} {\sum }_{m = 1}^{M} - {y}_{m , n} log {\hat{p}}_{m} ( {x}_{n} ; θ )$$

where N is the total number of observation windows, M is the number of subjects 12, 14 to be identified, m is a label, xₙ is a sample frame, y_{m,n} is either zero or unity depending on whether the label m is correct for the sample xₙ, and pₘ(xₙ;θ) is a predicted probability that example xₙ is subject m given the model parameter θ.

During testing, the subject m* with the highest predicted probability given the frames xᵢ is used to tag the corresponding tracklet:

$${m}^{*} = {arg max}_{m} {\hat{p}}_{m} ( {x}_{i} ; θ )$$

The process of labeling trajectories with the identity of the subject that generated the trajectory involves evaluating a similarity between acceleration data and tracklets. However, it is not useful to simply correlate acceleration data with tracklets. This is because a subject's limbs can move while the subject is stationary. For example, a subject 12, 14 whose foot taps in response to a beat while listening to or playing music will cause an ankle-mounted accelerometer 76 to generate spurious acceleration data.

To provide a more robust way to use acceleration data to learn about a subject's characteristics, it is useful to provide another dual-branch neural network, referred to herein as the “labeling network” 80 as shown in FIG. 6. The labeling network 80 has a first branch 82 and a second branch 84. The first branch 82 models acceleration and the second branch 84 models tracklets. Both branches 82, 84 use three layers of convolution along the temporal dimension with a kernel size of three. Each convolution layer is followed by a ReLU activation layer and a dropout layer.

During a particular observation window, the first and second branches 82, 84 receive concurrent tracklet and acceleration data. When necessary, tracklet data is padded with zeros to match the length of the acceleration data.

Based on the concurrent tracklet and acceleration data, the first and second branches 82, 84 each provide a feature vector to a multiplier 86. These feature vectors correspond to the two data types. The multiplier 86 evaluates the dot product of the two feature vectors as a basis for evaluating their similarity in each time step. Following the dot product, the process continues with max pooling in the temporal dimension and the use of a fully-connected layer 88 to produce a similarity score for the entire observation period.

The process for training the labeling network 80 includes collecting acceleration and tracklets generated by the same subject 12 as correct examples. It also includes randomly assigning acceleration streams to tracklets to create some number of wrong examples. As part of training, ground-truth similarity scores are set to unity and zero for correct and wrong pairs, respectively. The training process includes minimizing cross-entropy loss between true and predicted similarity scores using a stochastic gradient descent with an Adam optimizer.

Once the labeling network 80 has been trained, it can label data automatically at a new space 10. There is no need to re-train the labeling network 80. This differs from the identification network 35 because each space 10 will typically have different subjects with their own different identities. However, it is possible to automate the training of the identification network 35 using a single labeling network 80.

In some embodiments, one or more of the frame generator 30, trajectory generator 32, and identification module 34 are implemented by causing one or more processors associated with the data-processing system 28 to execute instructions that have been stored on a non-transitory computer-readable medium. An example of such a medium is semiconductor memory. Other examples include a magnetic disk. Instructions can be stored as software or firmware. In all such cases, a technical improvement in the operation of the data-processing system 28 arises because the data-processing system 28 has been rendered capable of carrying out operations that it would not otherwise have been able to carry out. In all such cases, the data-processing system 28 is a physical system that excludes the human mind. The implementations described herein are limited to non-abstract implementations that are executed outside the human mind. In other implementations, frame generator 30, trajectory generator 32, and identification module 34 implemented as electronic circuitry.

It is to be understood that the foregoing description is intended to illustrate and not to limit the scope of the invention, which is defined by the scope of the appended claims. Other embodiments are within the scope of the following claims.

1. A method for identifying one or more subjects moving through a space, the method comprising:
emitting a transmitted signal, the transmitted signal comprising repetitions of a transmitted-signal pattern;
receiving a reflected radio signal, the reflected radio signal comprising reflections of the transmitted signal;
processing the received signals to form successive patterns of reflections of the transmitted signal;
based on the successive patterns of reflections, determining a trajectory of a subject moving in the space; and
identifying the subject based at least in part on the trajectory.

2. The method of claim 1, wherein identifying the subject includes processing the trajectory of the subject moving in the space and the successive patterns of reflections of the transmitting signal for the subject using a classifier.

3. The method of claim 2, further comprising receiving training signals and using said training signals to determine configuration parameters for the classifier, said training signals comprising received reflected signals and corresponding motion signals, said motion signals having been collected using a device that moves with the subject.

4. The method of claim 3, wherein the corresponding motion signals include an acceleration signal generated by an accelerometer affixed to the subject.

5. An apparatus comprising
an antenna disposed for launching a transmitted radio-signal into a space and receiving a reflected radio-signal from a subject that is moving through said space, said transmitted radio-signal comprising repetitions of a transmitted-signal pattern,
a wireless sensor coupled to said antenna for generating said transmitted radio-signal and receiving said reflected radio-signal, and
a data-processing system configured to receive, from said wireless sensor, reflection data indicative of said reflected radio-signal, said reflection data representing successive patterns of reflection that result from having launched said transmitted radio-signal, said data-processing system comprising
a frame generator that generates, from said reflection data, a series of frames, each of which includes frame data indicative of a pattern of reflection at a particular time that corresponds to said frame, said series of frames defining a succession of patterns of reflections,
a trajectory generator that receives said frame data from said frame generator and obtains, from said patterns of reflections, trajectory data indicative of a trajectory of said subject through said space, and
an identification module that identifies said subject based at least in part on said trajectory.

6. The apparatus of claim 5, wherein said identification module comprises a neural network that has been trained to use said trajectory to identify said subject based on said subject's characteristic gait.

7. The apparatus of claim 5, wherein said identification module comprises a convolutional neural network that has been trained to use said trajectory to recognize said subject based on said subject's characteristic movements.

8. The apparatus of claim 5, wherein said identification module comprises a neural network that includes a multiplier for receiving said frame data and a mask that defines a volume along said trajectory, wherein said mask suppresses frame data that represents reflections from outside said volume.

9. The apparatus of claim 5, wherein said identification module comprises a neural network that comprises branches, each of which comprises multiple layers, said branches being connected to form a fully-connected layer, wherein each of said branches receives only a portion of said frame data.

10. The apparatus of claim 5, wherein said frame comprises projections of said data into subspaces of lower dimensionality than that of said space, wherein said identification module comprises multiple branches, each of which processes one of said projections, wherein each branch is a branch of a convolutional neural network, and wherein said branches combine to form a fully-connected layer of said convolutional neural network.

11. The apparatus of claim 5, wherein said identification module comprises a neural network that includes first and second branches, a fully-connected layer at which said first and second branches connect, a first multiplier that applies a first mask to a first projection to form a masked first-projection that is to be processed by said first branch, and a second multiplier that applies a second mask to a second projection to form a masked second-projection that is to be processed by said second branch, said first projection being a projection of said frames into a first sub-space of said space, said second projection being a projection of said frames into a second sub-space of said space, wherein said first mask defines a volume along a projection of said trajectory into said first sub-space such that, when applied to said first projection, said first mask suppresses reflections from outside said volume and wherein said second mask defines a volume along a projection of said trajectory into said second sub-space, such that, when applied to said second projection, said second mask suppresses reflections from outside said volume.

12. The apparatus of claim 5, wherein said identification module further comprises an identification network that is trained to recognize said subject based on characteristics of said subject's gait and wherein said data-processing system is further configured to receive data representative of movement of said subject during a training period.

13. The apparatus of claim 5, wherein said identification module further comprises an identification network that is trained to recognize said subject based on characteristics of said subject's movement and on said subject's body characteristics and wherein said data-processing system is further configured to receive data representative of movement of said subject during a training period.

14. The apparatus of claim 5, wherein said identification module further comprises a neural network that is configured to recognize said subject based on said subject's spatial and temporal features and wherein said network comprises layers that carry out spatial and temporal convolution of said data.

15. The apparatus of claim 5, wherein said data-processing system is configured to receive acceleration data from an accelerometer that is being worn by said subject and to use said acceleration data to learn characteristics of said subject's movement for use in identifying said subject from observing said subject's motion through said space after said subject has removed said accelerometer.

16. The apparatus of claim 5, wherein said identification module further comprises a neural network comprising a motion branch and a position branch, said motion branch configured to process data indicative of said subject's motion and said position branch being configured to process data representative of said trajectory, wherein said first and second branches combine at a fully-connected layer.

17. The apparatus of claim 5, wherein said identification module further comprises a neural network that is trained by varying a model parameter to minimize a cross-entropy loss.

18. The apparatus of claim 5, wherein said antenna comprises antenna elements that extend along first and second perpendicular directions corresponding to first and second portions of said frame data.

19. The apparatus of claim 5, wherein said transmitted signal pattern comprises a pattern of an FMCW signal.

20. The apparatus of claim 5, wherein said subject is a first subject of a plurality of subjects, all of whom move through said space concurrently and wherein said identification module is configured to identify each of said subjects based at least in part on a trajectory that corresponds to said subject.
